(19) United States
(12) Patent Application Publication
(10) Pub. No.: US 2016/0114658 A1
(43) Pub. Date: Apr. 28, 2016

(54) VEHICLE DOOR FRAME

(71) Applicant: SHIROKI CORPORATION, Kanagawa (JP)

(72) Inventors: Kazuyoshi YOKOTA, Kanagawa (JP); Jun MAKITA, Kanagawa (JP); Shunsuke TANAKA, Kanagawa (JP); Yuji MORI, Kanagawa (JP)

(73) Assignee: SHIROKI CORPORATION, Kanagawa (JP)

(21) Appl. No.: 14/922,317

(22) Filed: Oct. 26, 2015

(30) Foreign Application Priority Data
Oct. 28, 2014 (JP) 2014-218911

(51) Int. Cl. B60J 5/04; B62D 65/08

(52) U.S. Cl. CPC B60J 5/0402; B60J 10/08; B60J 10/0088

(57) ABSTRACT

A vehicle door frame includes a base and a projecting portion, which projects from a surface of the base, wherein a first side of the projecting portion and a second side of the projecting portion extend along a lengthwise direction of the vehicle door frame, and a recess is formed in the first side of the projecting portion and is recessed toward the second side of the projecting portion.

### BACKGROUND OF THE INVENTION

1. Field of the Invention

The present invention relates to a door frame as a component of a vehicle door.

2. Description of Related Art

Door frames (door sashes) that constitute components of vehicle doors are formed as elongated members manufactured of a metallic material and are partly modified in cross sectional shape as required. For instance, in a door frame having a cross sectional shape including a projecting portion which projects from a predetermined base of the door frame, sometimes a part(s) of the projecting portion in the lengthwise direction is cut off. Japanese Unexamined Patent Publication No. 2007-145282 discloses part of an elongated projecting portion being cut off from a door frame after the door frame has been formed, wherein the elongated projecting portion projects from the door frame to form an engaging groove for holding a weather strip.

When the projecting portion is partly cut off from the door frame, the cut-off process is required to be performed smoothly in order to smoothen out the cut-off trace, as much as possible, that is created upon cutting.

### SUMMARY OF THE INVENTION

The present invention has been devised in view of the above described demand, and the present invention provides a vehicle door frame which is superior in workability and working accuracy when the projecting portion that projects from the base of the vehicle door frame is partly cut off.

According to an aspect of the present invention, a vehicle door frame is provided, including a base and a projecting portion, which projects from a surface of the base, wherein a first side of the projecting portion and a second side of the projecting portion extend along a lengthwise direction of the vehicle door frame, and a recess is formed in the first side of the projecting portion and is recessed toward the second side of the projecting portion.

It is desirable for the recess to be positioned at a boundary between the projecting portion and the base to be recessed into the first side of the projecting portion while being recessed into the surface of the base.

It is desirable for a second recess to be formed in the door frame at a boundary between the second side of the projecting portion and the surface of the base to be recessed into the surface of the base.

It is desirable for the surface of the base to include two surfaces which are respectively formed on either side of the projecting portion at different positions relative to a projecting direction of the projecting portion.

The present invention is applicable to projecting portions of various shapes that constitute components of door frames. As an example of such projecting portions, the vehicle door frame can include a frame portion which includes an inner peripheral side portion which is adjacent to a window opening, an outer peripheral side portion positioned on an opposite side of the inner peripheral side portion relative to the window opening, and a connecting portion which connects the inner peripheral side portion with the outer peripheral side portion; an extension portion which extends toward a vehicle exterior side from the outer peripheral side portion of the frame portion; and a weather strip holding portion which holds a weather strip on the extension portion on the outer peripheral side. The projecting portion projects toward the outer peripheral side, with at least one of the outer peripheral side portion and the extension portion serving as the base, to form the weather strip holding portion.

It is desirable for the base and the projecting portion to be elongated in the lengthwise direction of the vehicle door frame, wherein a part of the projecting portion in the lengthwise direction of the vehicle door frame is cut off from the surface of the base.

According to the present invention, the formation of the recess on the projecting portion makes it possible to improve workability and working accuracy when the projecting portion is partly cut off.

The present disclosure relates to subject matter contained in Japanese Patent Application No. 2014-218911 (filed on Oct. 28, 2014) which is expressly incorporated herein by reference in its entirety.

### BRIEF DESCRIPTION OF THE DRAWINGS

The present invention will be discussed below in detail with reference to the accompanying drawings, in which:

FIG. 1 is a side elevational view of a motor-vehicle side door for use as a front-seat door to which a vehicle door frame according to the present invention has been applied, viewed from the vehicle interior side;

FIG. 2 is a cross sectional view of the upper sash of a first embodiment of the door frame according to the present invention and part of a cutting tool;

FIG. 3 is an enlarged view of a portion of the cross sectional view shown in FIG. 2;

FIG. 4 is a view similar to that of FIG. 2, illustrating a process of cutting off part of the holding projection of the first embodiment of the upper sash using the cutting tool;

FIG. 5 is a cross sectional view of a portion of the upper sash of the first embodiment of the door frame, illustrating a cut-off trace that remains after cutting off part of the holding projection of the first embodiment of the upper sash;

FIG. 6 is a view similar to that of FIG. 3, illustrating a portion of the upper sash, in the vicinity of the holding projection thereof, of a second embodiment of the door frame according to the present invention and part of the cutting tool;

FIG. 7 is a view similar to that of FIG. 3, illustrating a portion of the upper sash, in the vicinity of the holding projection thereof, of a third embodiment of the door frame according to the present invention and part of the cutting tool;

FIG. 8 is a cross sectional view of the upper sash of a fourth embodiment of the door frame according to the present invention;

FIG. 9 is an enlarged view of a portion of the sectional view shown in FIG. 8 and part of a cutting tool;

FIG. 10 is a cross sectional view of the lower sash of a fifth embodiment of the door frame according to the present invention;

FIG. 11 is an enlarged sectional view of a portion of the lower sash shown in FIG. 10 and part of a cutting tool;

FIG. 12 is a view similar to that of FIG. 2, illustrating the upper sash of a comparative example of a door frame and part of a cutting tool;

FIG. 13 is a view similar to that of FIG. 2, illustrating a process of partly cutting off the holding projection of the upper sash of the comparative example of the door frame using the cutting tool; and

FIG. 14 is a view similar to that of FIG. 5, illustrating a cut-off trace that remains after cutting off part of the holding projection of the comparative example of the upper sash.

### DESCRIPTION OF THE EMBODIMENTS

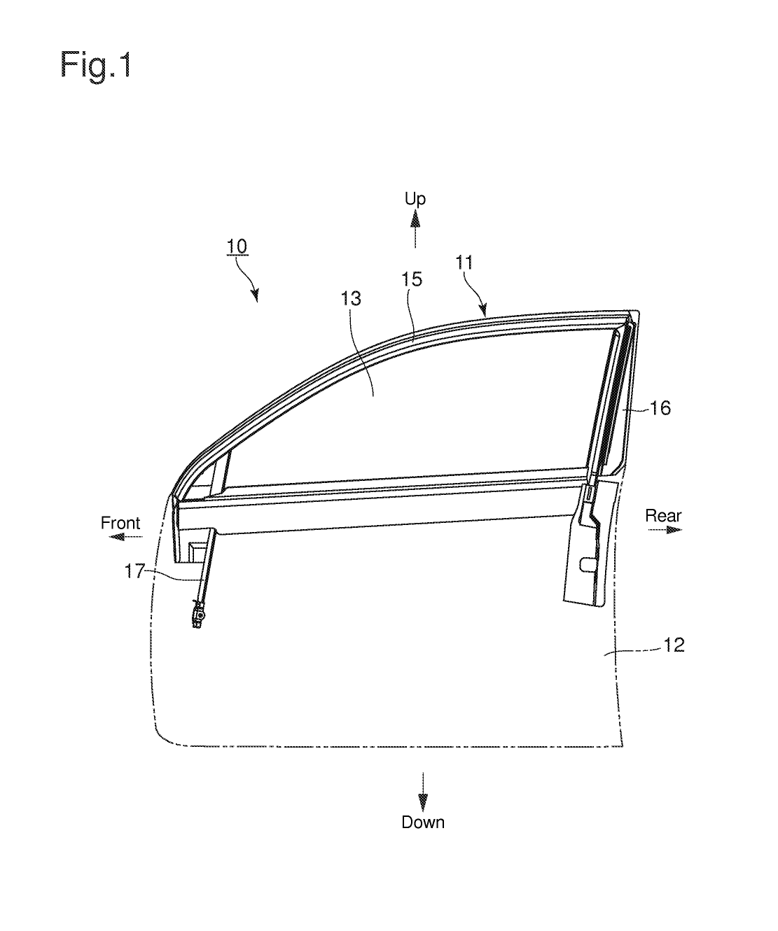

FIG. 1 shows a motor-vehicle front door 10 (hereinafter referred to as the door 10) to which a vehicle door frame according to the present invention has been applied. The door 10 is provided with a door frame (door sash) 11 and a door panel 12. A window opening 13 is defined (surrounded) by the inner peripheral edge of the door frame 11 and the upper edge of the door panel 12 of the door 10. The door 10 is provided with a door glass (not shown) which moves up and down in the window opening 13. When the door 10 is closed, the associated door opening (not shown) formed in the vehicle body is closed by the door 10. In the following description, the side of the door frame 11 adjacent to (facing) the window opening 13 is referred to as the “inner peripheral side”, and the opposite side of the door frame 11 from the inner peripheral side thereof is referred to as the “outer peripheral side”. Additionally, terms indicating a direction such as the “front”, “rear”, “up”, “down”, “vehicle interior side” and “vehicle exterior side” will be mentioned in the following description to designate directions determined with reference to the vehicle body, to which the door 10 that is used as a front-seat door is attached.

The door frame 11 is provided with an upper sash 15 that defines the upper edge portion of the door 10, an upright pillar sash 16 which extends upwardly from a rear part of the door panel 12, and a lower sash 17 which is supported by the door panel 12 in the vicinity of the front end thereof. The rear end of the upper sash 15 and the upper end of the upright pillar sash 16 are joined together, and the upper sash 15 is formed to extend forward from the joint between the upper sash 15 and the upright pillar sash 16 to the front of the door panel 12. The upper end of the lower sash 17 is connected to the upper sash 15 at a location that is close to the front end thereof. The front edge and the rear edge of the door glass are held by the lower sash 17 and the upright pillar sash 16, respectively, to allow the door glass to move up and down along the lower sash 17 and the upright pillar sash 16. Upon the door glass moving to the upper moving limit thereof in the window opening 13, the upper edge of the door glass is held by the upper sash 15.

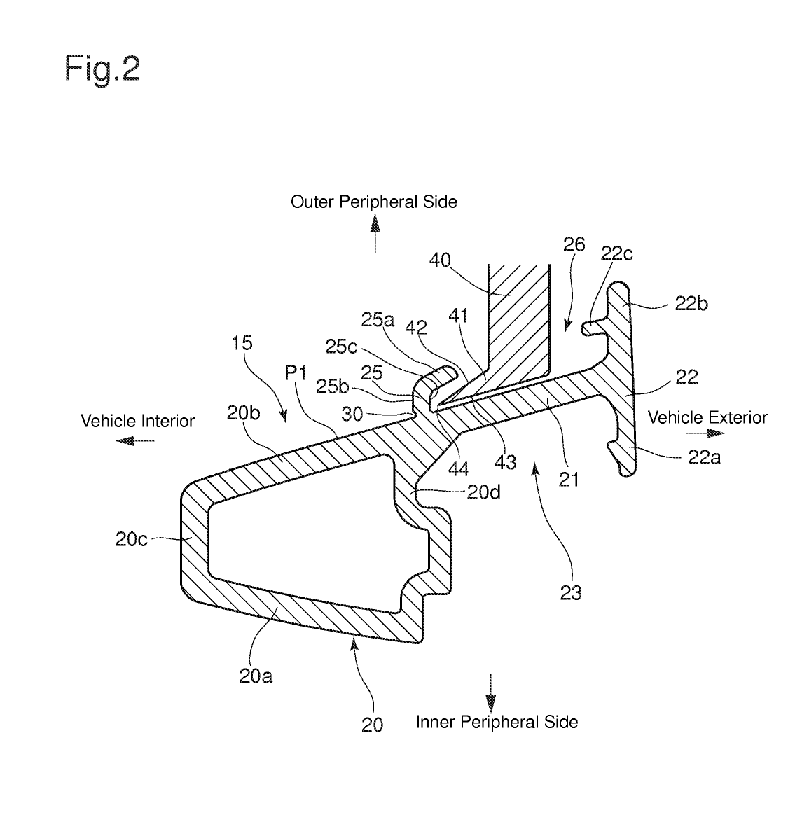

The first embodiment of the door frame 11 according to the present invention will be hereinafter discussed with reference to FIGS. 2 through 5. FIG. 2 shows the upper sash 15 in cross section along a plane substantially orthogonal to the lengthwise direction of the upper sash 15. The upper sash 15 is extrusion molded using aluminum as a material.

The upper sash 15 is provided with a vehicle interior-side frame portion 20, an extension portion 21 and a design portion 22. The vehicle interior-side frame portion 20 is positioned on the vehicle interior side, the extension portion 21 extends toward the vehicle exterior side, and the design portion 22 is connected to the vehicle exterior-side end of the extension portion 21. The vehicle interior-side frame portion 20 has the shape of a hollow-tubular body provided with an inner peripheral side portion 20a, an outer peripheral side portion (base) 20b, a connecting portion 20c and a connecting portion 20d. The inner peripheral side portion 20a is positioned on the inner peripheral side, adjacent to the window opening 13, and the outer peripheral side portion 20b is positioned on the outer peripheral side to face the inner peripheral side portion 20a. The vehicle interior-side ends of the inner peripheral side portion 20a and the outer peripheral side portion 20b are connected via the connecting portion 20c, and the vehicle exterior-side ends of the inner peripheral side portion 20a and the outer peripheral side portion 20b are connected via the connecting portion 20d. The extension portion 21 is formed at a position on an extension of the outer peripheral side portion 20b of the vehicle interior-side frame portion 20. The design portion 22 is provided with an inner peripheral projecting portion 22a and an outer peripheral projecting portion 22b. The inner peripheral projecting portion 22a projects toward the inner peripheral side from the portion of the design portion 22 to which the extension portion 21 is connected, and the outer peripheral projecting portion 22b projects toward the outer peripheral side from the portion of the design portion 22 to which the extension portion 21 is connected. The inner peripheral projecting portion 22a and the outer peripheral projecting portion 22b lie on a common plane.

The upper sash 15 is provided with a glass-guide portion (glass run retaining portion) 23 which is formed as a recessed portion defined by the connecting portion 20d of the vehicle interior-side frame portion 20, the extension portion 21 and the inner peripheral projecting portion 22a of the design portion 22. The glass-guide portion 23 has a shape that is open toward the inner peripheral side. A glass run (not shown) made of an elastic material is held in the glass-guide portion 23. An edge (the upper edge) of the door glass can enter into the glass-guide portion 23 to be held by the glass run therein.

The surface of the outer peripheral side portion 20b of the vehicle interior-side frame portion 20 which faces toward the outer peripheral side (i.e., the upper surface of the outer peripheral side portion 20b with respect to FIG. 2) and the surface of the extension portion 21 which faces toward the outer peripheral side (i.e., the upper surface of the extension portion 21 with respect to FIG. 2) lie on a common plane with each other (i.e., are not stepped relative to each other). These two surfaces will be defined as a base surface P1. The upper sash 15 is provided, on a portion thereof in the vicinity of the boundary between the outer peripheral side portion 20b and the extension portion 21, with a holding projection 25 which projects toward the outer peripheral side from the base surface P1. The upper sash 15 is provided with a weather strip holding portion 26 which is formed as a recess defined by the holding projection 25, the extension portion 21 and the outer peripheral projecting portion 22b of the design portion 22, and a weather strip (not shown) made of an elastic material is held in the weather strip holding portion 26 thereby. The holding projection 25 is provided at the end (free end) thereof with a bent portion 25a which bends toward the vehicle exterior side (toward the outer peripheral projecting portion 22b), and the outer peripheral projecting portion 22b is provided with a projection 22c which projects toward the vehicle interior side (toward the bent portion 25a). The aforementioned weather strip (not shown) is provided with a leg portion which is fitted into the weather strip holding portion 26 and an elastic contact portion which projects toward the outer peripheral side from the leg portion, and the bent portion 25a and the projection 22c are engaged with the leg portion of the weather strip to prevent the leg portion of the weather strip from coming off the weather strip holding portion 26. When the door 10 is closed, the elastic contact portion of the weather strip comes into elastic contact with the vehicle body at the outer periphery of the associated door opening (not shown), thereby making the gap between the door 10 and the vehicle body watertight.

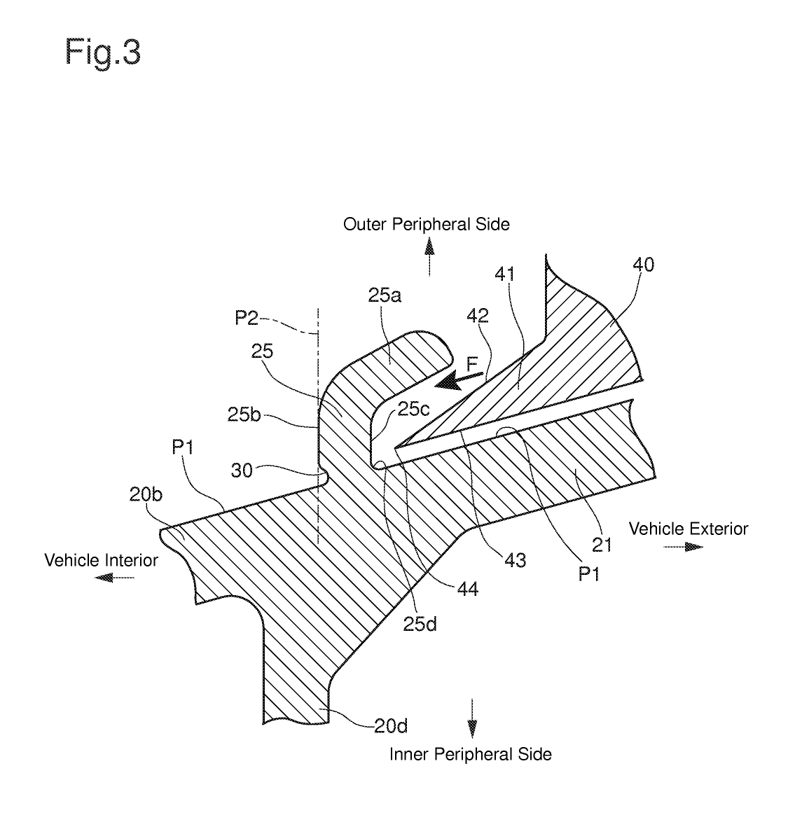

The holding projection 25 is provided (between the bent portion 25a and the base surface P1) with a first side 25b which faces toward the vehicle interior side and a second side 25c which faces toward the vehicle exterior side. The first side 25b and the second side 25c are flat surfaces which are substantially parallel to each other and extend in the lengthwise direction of the upper sash 15, and the distance between the first side 25b and the second side 25c corresponds to the thickness of the holding projection 25 (in a direction connecting the vehicle interior side with the vehicle exterior side). As can be seen from FIG. 3, the upper sash 15 is provided at the boundary between the second side 25c and the base surface P1 with a rounded internal corner 25d, the surface of which slightly curves between the second side 25c and the base surface P1. The upper sash 15 is provided, on a portion of the first side 25b in the close vicinity of the base end of the holding projection 25 adjacent to the base surface P1, with a recess 30 which is recessed toward the second side 25c so that the portion of the holding projection 25 at which the recess 30 is formed is smaller in thickness than the remaining portion of the holding projection 25. For the sake of clarifying the formation of the recess 30 on the first side 25b, an imaginary plane P2 in which an extension of the first side 25b lies is shown by a one-dot chain line in FIG. 3.

The upper sash 15 is formed to include the holding projection 25 at general cross sections of the upper sash 15 in the lengthwise direction thereof, which occupy the major part of the upper sash 15, and not to include the holding projection 25 in some other regions of the upper sash 15 such as the region in the vicinity of the joint to the upright pillar sash 16. When forming the upper sash 15, the upper sash 15 is initially formed to be uniform in cross sectional shape so as to include the holding projection 25 along the entirety of the upper sash 15 in the lengthwise direction thereof, and thereafter, the holding projection 25 is partly cut off using a cutting tool 40 shown in FIGS. 2 through 4 (at predetermined sections in the lengthwise direction of the upper sash 15).

The cutting tool 40 is provided with a blade 41 which consists of a cutting face 42, a flank 43 and a cutting edge 44. As shown in FIGS. 2 and 3, the cutting tool 40 is inserted into the weather strip holding portion 26 when the holding projection 25 is being partly cut off, and the orientation of the blade 41 is set to make the cutting face 42 face the bent portion 25a, to make the flank 43 face the extension portion 21 and to make the cutting edge 44 face the second side 25c. The cutting tool 40 is set so as to establish a predetermined clearance between the flank 43 and the base surface P1 to prevent an adverse effect on work accuracy which may be caused by the abutment of the cutting edge 44 of the cutting tool 40 against the rounded internal corner 25d.

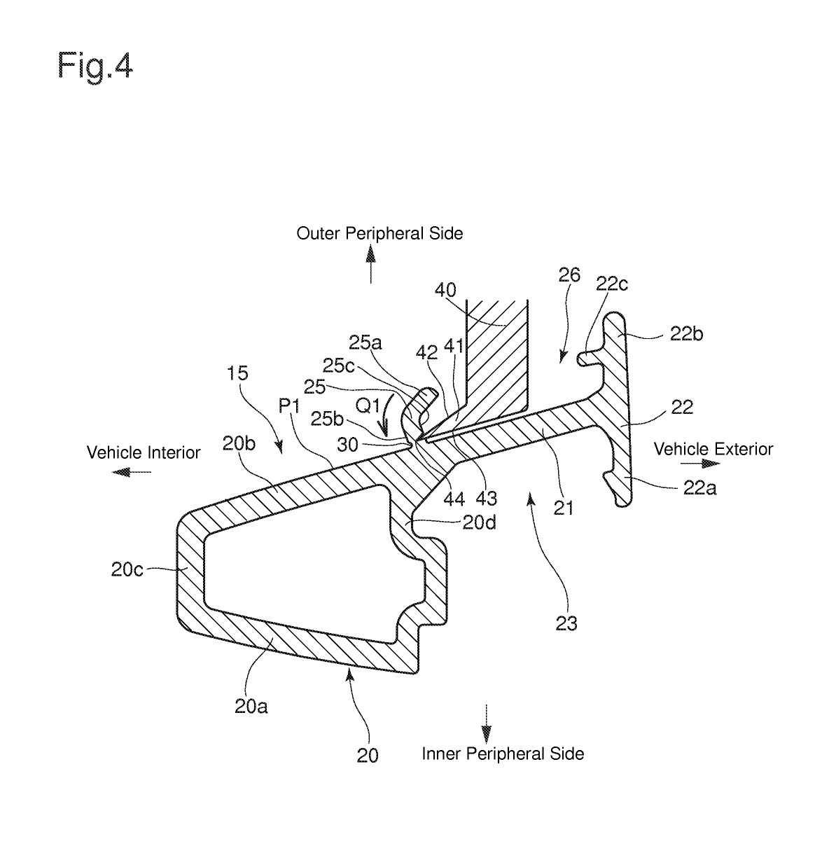

From this state shown in FIG. 3, the cutting tool 40 is moved in a working direction shown by an arrow F in FIG. 3 (that is pointed toward the vehicle interior side) so that the cutting edge 44 of the blade 41 cuts into the second side 25c of the holding projection 25, and thereupon, the cutting tool 40 starts cutting the holding projection 25. At this stage, the holding projection 25 which receives a pressing force from the cutting tool 40 in the working direction shown by the arrow F (see FIG. 3) is acted upon by a force shown by an arrow Q1 shown in FIG. 4 which urges the holding projection 25 to buckle toward the vehicle interior side with the recess 30 acting as a buckling point. With the holding projection 25 being subjected to a moment in the buckling direction in such a manner, the blade 41 easily cuts into the holding projection 25 from the second side 25c. The portion of the holding projection 25 is cut off from the base surface P1 upon the cutting edge 44 cutting into the holding projection 25 and reaching the first side 25b. The formation position of the recess 30 in the projecting direction of the holding projection 25 is set to substantially correspond to the cut-in position of the cutting tool 40. More specifically, setting the buckling point of the holding projection 25 at a position slightly closer to the base surface P1 than the input point of the aforementioned pressing force (the contact point of the cutting edge 44 with the second side 25c) that the holding projection 25 receives from the cutting tool 40 allows the force Q1 to easily occur in the buckling direction.

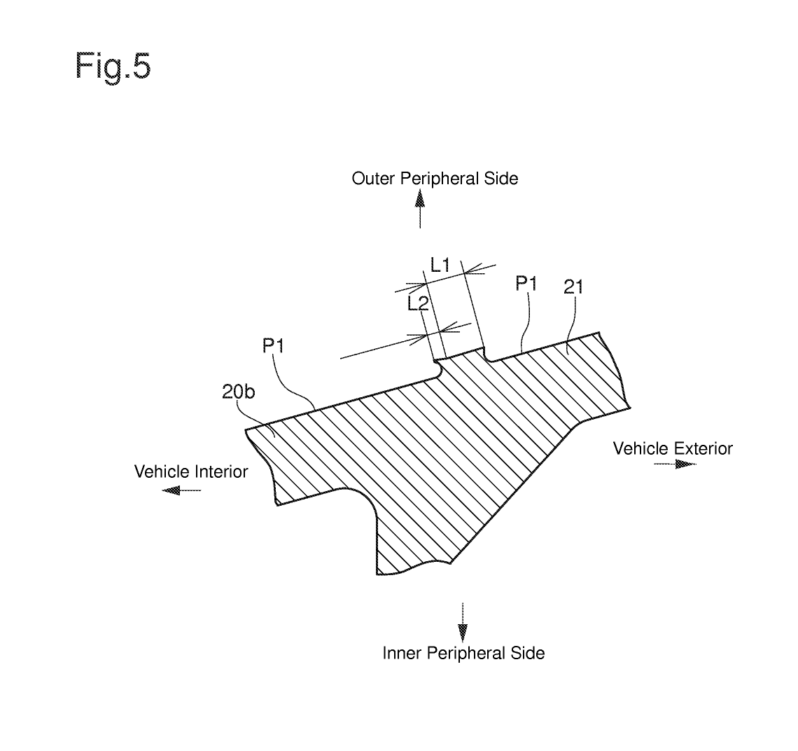

FIG. 5 shows a cut-off trace that remains after part of the holding projection 25 has be cut off using the cutting tool 40. As shown in FIG. 5, the cut-off trace includes a smooth cutting region L1, having a smooth cutting surface (sheared surface) formed by the blade 41 passing (cutting) therealong, and a fracture region L2 having a fracture surface formed upon part of the holding projection 25 being sheared off. The smooth cutting region L1 ranges from the second side 25c to a predetermined position in the thickness direction of the holding projection 25, and the fracture region L2 ranges from this predetermined position to the first side 25b in the thickness direction of the holding projection 25. A burr is formed at the end of the fracture region L2 on the first side 25b side. Due to the formation of the recess 30, the smooth cutting region L1 covers approximately 80 percent of the cut-off trace, so that the fracture region L2 remains at approximately 20 percent of the cut-off trace. In addition, the amount of projection of the burr (in the projecting direction of the holding projection 25 toward the outer peripheral side) is also small.

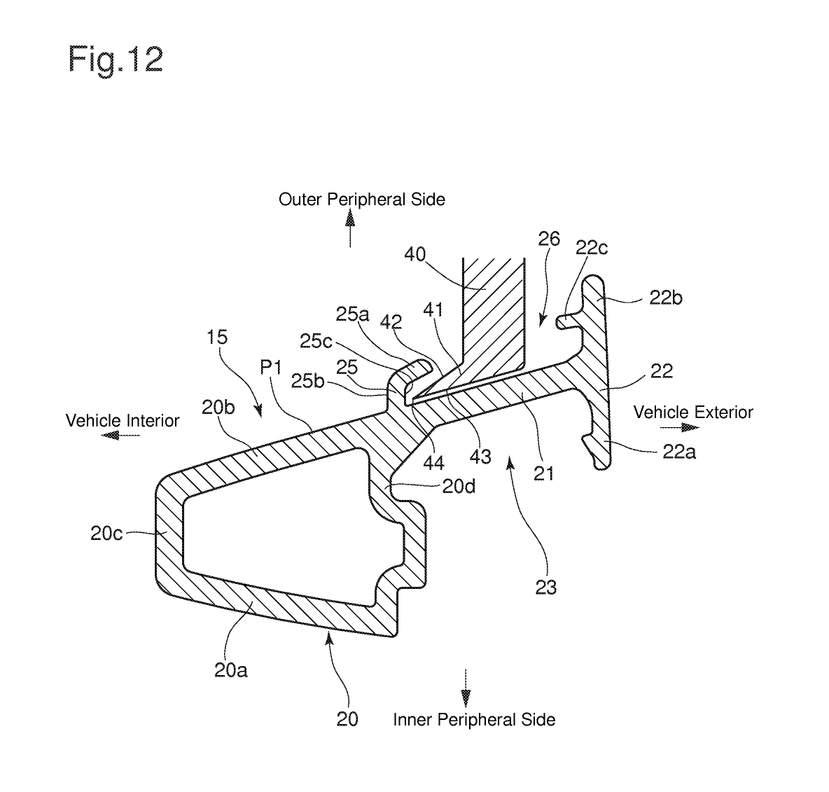

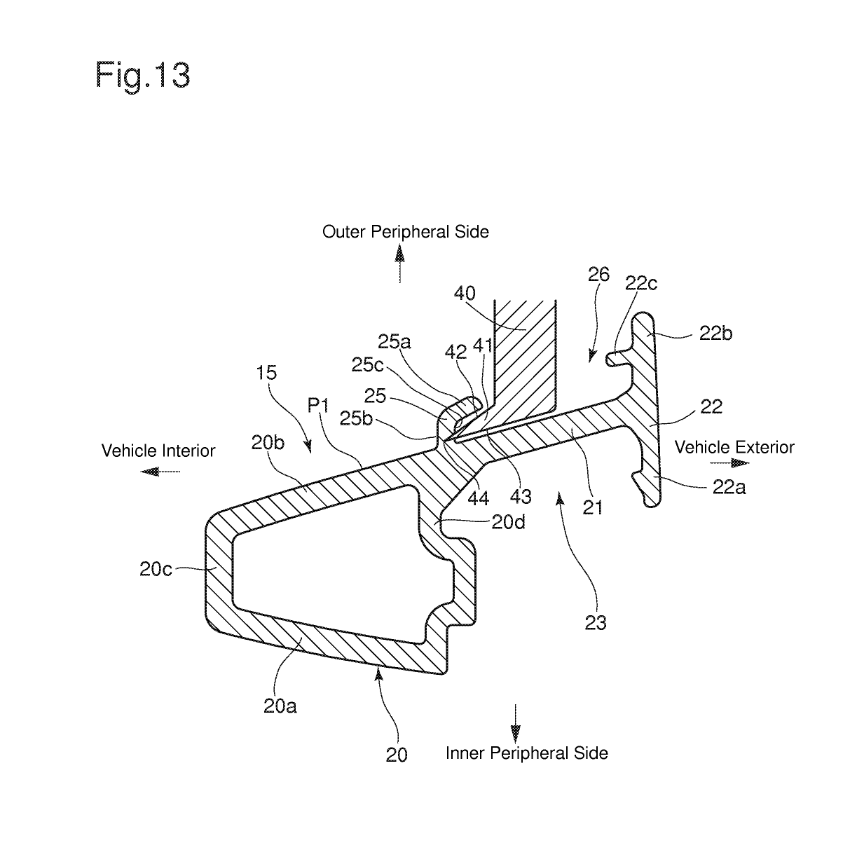

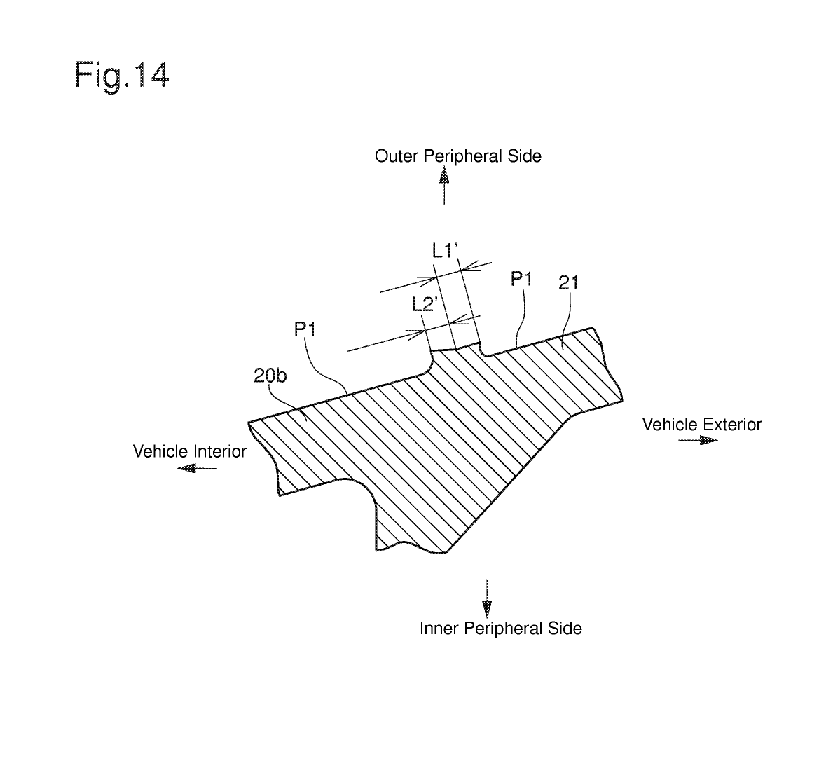

FIGS. 12 through 14 show a comparative example. Elements and parts which are similar to those of the above described first embodiment of the door frame are designated by the same reference numerals. This comparative example is different from the first embodiment of the door frame in that the recess 30 is not formed in the holding projection 25 in the comparative example. Since the recess 30 is not formed in the holding projection 25 in the comparative example, when the holding projection 25 is in the process of being cut, this cutting process does not induce the holding projection 25 to buckle (lean) toward the vehicle interior side as shown in FIG. 13. This increases the resistance in the holding projection 25 to be cut into when the cutting edge 44 of the blade 41 is made to cut into the second side 25c of the holding projection 25, so that rupture takes place at a relatively early stage, thus the cutting surface tends to be rough. FIG. 14 shows a cut-off trace that remains after part of the holding projection 25 has been cut off in the comparative example. In the cut-off trace of this comparative example, the smooth cutting region L1′ covers approximately 50 percent of the cut-off trace, while the fracture region L2′, in which a fracture surface is formed by a sudden deformation of the holding projection 25, covers approximately 50 percent of the cut-off trace. In addition, the amount of projection of the burr (in the projecting direction of the holding projection 25 toward the outer peripheral side), which is formed at the end of the fracture region L2′ on the first side 25b side, is greater than that in the first embodiment of the door frame.

As can be understood from the comparison between the first embodiment of the door frame and the comparative example, the formation of the recess 30 on the first side 25b that is on the opposite side of the holding projection 25 from the second side 25c, into which the cutting tool 40 is cut, makes it possible to perform the cut-off process smoothly to thereby achieve a cut-off trace, the cut surface thereof having a high level of smoothness.

Although the base surface P1, from which the holding projection 25 projects, substantially lies on single plane (so that the base surface P1 on one side of the holding projection 25 is not stepped relative to the other) in the first embodiment of the door sash, the present invention is also applicable to a door sash in which a holding projection corresponding to the holding projection 25 projects from a base surface that is stepped on one side of the holding projection 25 relative to the other side thereof.

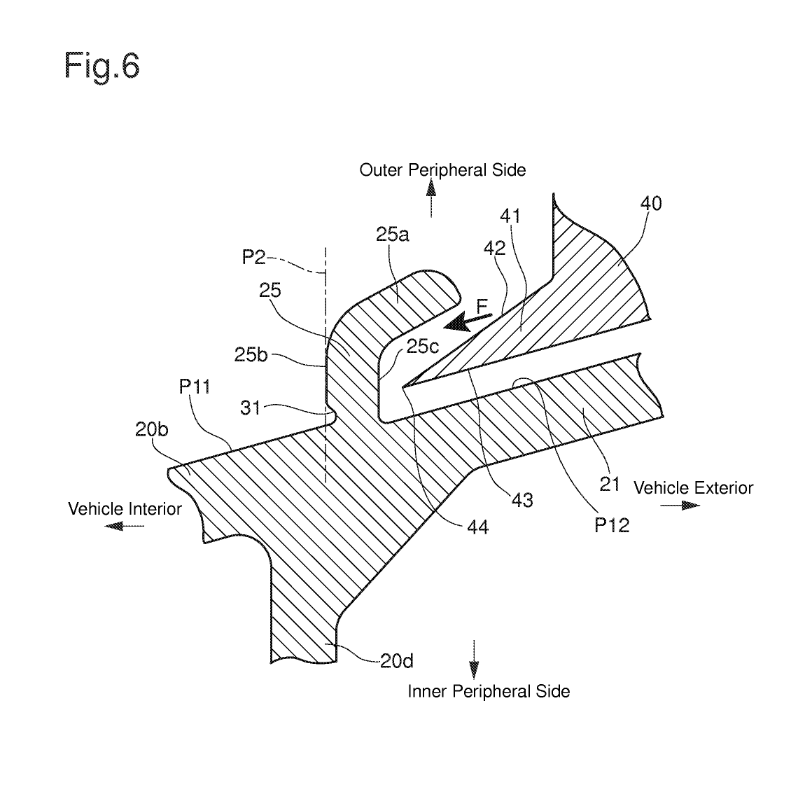

In the second embodiment of the door frame shown in FIG. 6, a base surface P11 (which corresponds to the base surface P1 of the first embodiment) on the outer peripheral side portion 20b of the vehicle interior-side frame 20 is positioned closer to the outer peripheral side than a base surface P12 (which corresponds to the base surface P1 of the first embodiment) on the extension portion 21, so that a step exists between the base surface P11 and the base step P12. A recess 31, which corresponds to the recess 30 of the first embodiment, is formed in a portion of the first side 25b at the base end of the holding projection 25 adjacent to the base surface P11. The position of the blade 41 of the cutting tool 40 relative to the recess 31 of the second embodiment when the holding projection 25 is partly cut off is set in a similar manner to the position of the blade 41 of the cutting tool 40 relative to the recess 30 of the first embodiment when the holding projection 25 is partly cut off.

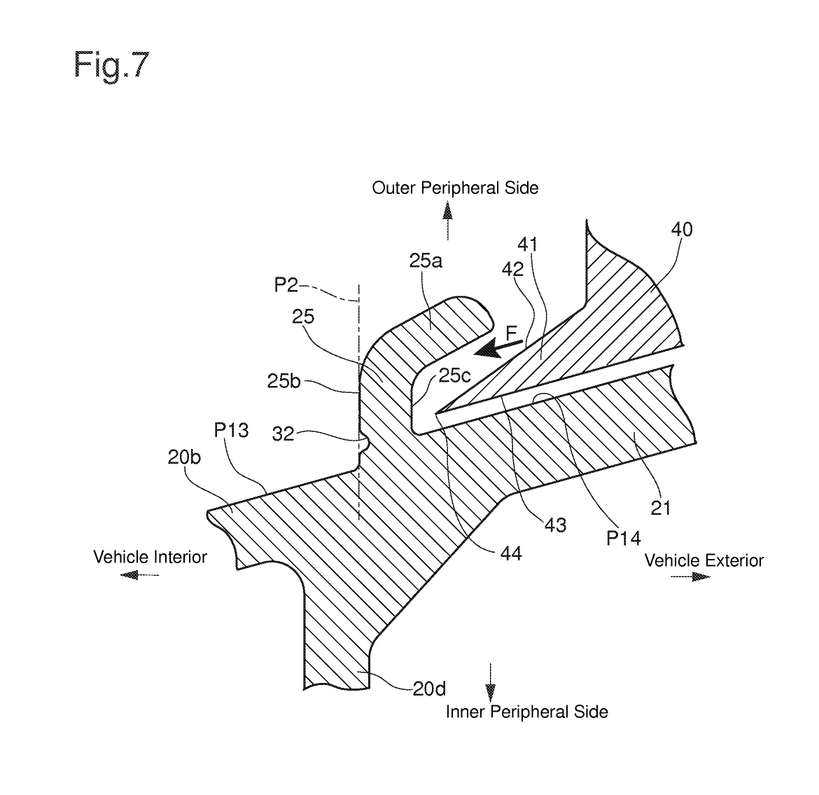

In the third embodiment of the door frame shown in FIG. 7, in contrast to the second embodiment of the door sash, a base surface P13 (which corresponds to the base surface P1 of the first embodiment) on the outer peripheral side portion 20b of the vehicle interior-side frame 20 is positioned closer to the inner peripheral side than a base surface P14 (which corresponds to the base surface P1 of the first embodiment) on the extension portion 21 so that a step is created between the base surface P13 and the base step P14. The recess 32 is formed at a position in the vicinity of a position on an extension of the base surface P14. Namely, the recess 32 is formed at a position advanced a step toward the outer peripheral side from the base end of the first side 25b (i.e., from the base surface P13). The position of the blade 41 of the cutting tool 40 relative to the recess 32 of the third embodiment when the holding projection 25 is partly cut off is set in a similar manner to the position of the blade 41 of the cutting tool 40 relative to the recess 30 of the first embodiment when the holding projection 25 is partly cut off.

An effect similar to that obtained by the formation of the recess 30 of the first embodiment can also be obtained by the formation of either of the recesses 31 and 32 of the second and third embodiments, respectively, when the holding projection 25 is partly cut off using the cutting tool 40.

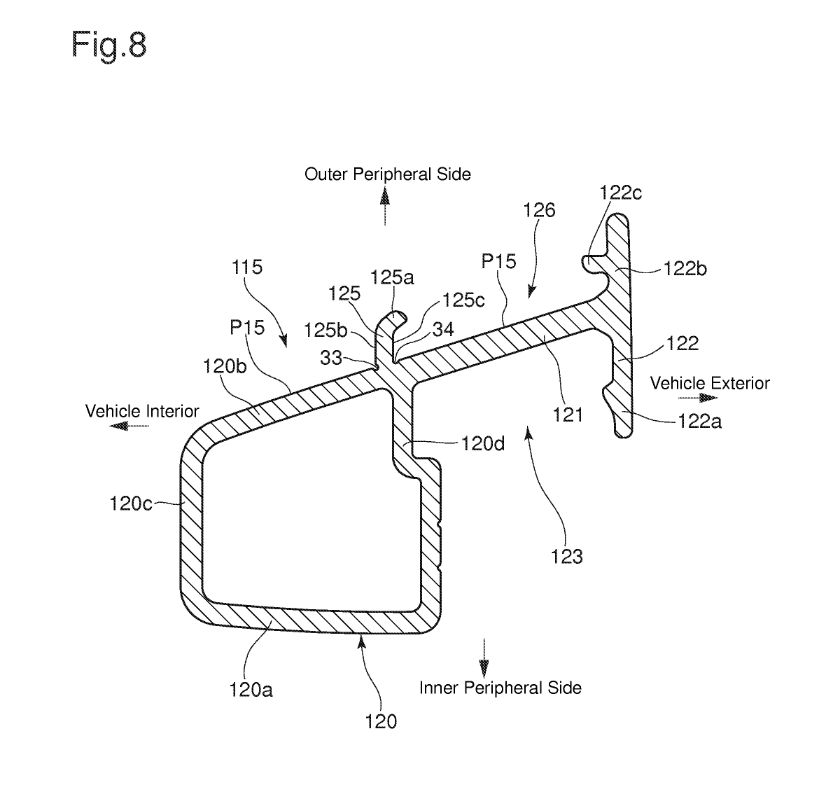

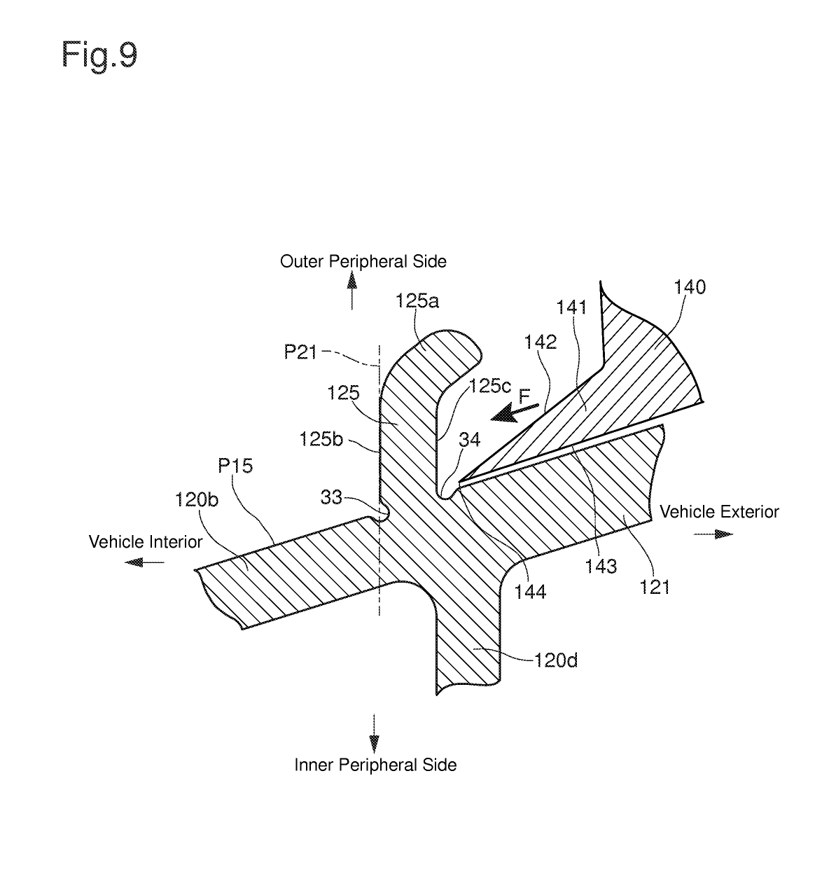

FIGS. 8 and 9 show the fourth embodiment of the door frame according to the present invention. This door frame is provided with an upper sash 115 shown in FIG. 8 which is substantially the same in basic structure as the upper sash 15 of the first embodiment while differing in the detailed shape thereof. Elements of the fourth embodiment of the door frame which are functionally similar to those of the first embodiment of the door frame are designated with similar reference numerals as the first embodiment of the door frame they are prefixed with a ‘1’ (therefore, the reference numerals of such similar elements are designated with three-digit numbers) to be distinguished from the elements of the first embodiment of the door frame; detailed descriptions of such similar elements are omitted from the following description.

Similar to the upper sash 15 of the first embodiment of the door frame, the surface of an outer peripheral side portion (base) 120b of a vehicle interior-side frame portion 120 which faces toward the outer peripheral side and the surface of an extension portion 121 which faces toward the outer peripheral side lie on a common plane with each other (i.e., are not stepped relative to each other) in an upper sash 115 of the fourth embodiment of the door frame. These surfaces are herein defined as a base surface P15. A holding projection 125 that projects toward the outer peripheral side from the base surface P15 is provided at the base of a first side 125b of the holding projection 125 with a recess 33 and is provided at the base of a second side 125c of the holding projection 125 with a second recess 34. As shown in FIG. 9, the recess 33 is formed at the boundary between the first side 125b and the base surface P15. The recess 33 is recessed toward the second side 125c from the first side 125b (from an imaginary surface P21 (shown by a one-dot chain line in FIG. 9) in which an extension of the first side 125b lies)) and also toward the inner peripheral side from the base surface P15. The second recess 34 is recessed toward the inner peripheral side from the base surface P15 in a manner to lengthen the second side 125c toward the inner peripheral side.

When the holding projection 125 is partly cut off from the upper sash 115, the cutting edge 144 of the blade 141 of a cutting tool 140 shown in FIG. 9 is brought into contact with and cut into the second side 125c of the holding projection 125, and subsequently, the cutting tool 140 continues to be moved in the working direction F until the blade 141 passes through the first side 125b. Unlike the holding projection 25 of the first embodiment that includes the rounded internal corner 25d at the base end of the second side 25c, in the holding projection 125, the second side 125c maintains the flatness thereof to the position of the base surface P15 due to the formation of the second recess 34. Therefore, the cutting edge 144 can be securely (reliably) brought into contact with the second side 125c even if the blade 141 (the flank 143 of the blade 141) of the cutting tool 140 is moved closer to the base surface P15. When the holding projection 125 is in the process of being cut with the cutting tool 140, the holding projection 125 is acted upon by a force which urges the holding projection 125 to buckle toward the vehicle interior side with the recess 33 acting as a buckling point, so that the recess 33 produces an effect similar to the effect produced by the recess 30 of the first embodiment; namely, the formation of the recess (30/33) makes it easy for the blade (41/141) to cut into the holding projection (25/125). As described above, in the fourth embodiment of the door panel, the formation of the second recess 34 in addition to the recess 33 makes it possible to bring the cutting position of the holding projection 125 by the cutting tool 140 closer to the base surface P15, thus making it possible to reduce the amount of projection of the cut-off trace of the holding projection 125 from the base surface P15.

In each of the above illustrated embodiments of the door frames, the present invention has been applied to the upper sash 15 or 115 of the door frame 11; however, the present invention is also applicable to parts of a door frame other than the upper sash. For instance, the upright pillar sash 16 has a weather strip holding portion similar to the upper sash 15 and also has a holding projection corresponding to the holding projection 25; accordingly, the present invention can also be applied to the holding projection of the upright pillar sash 16.

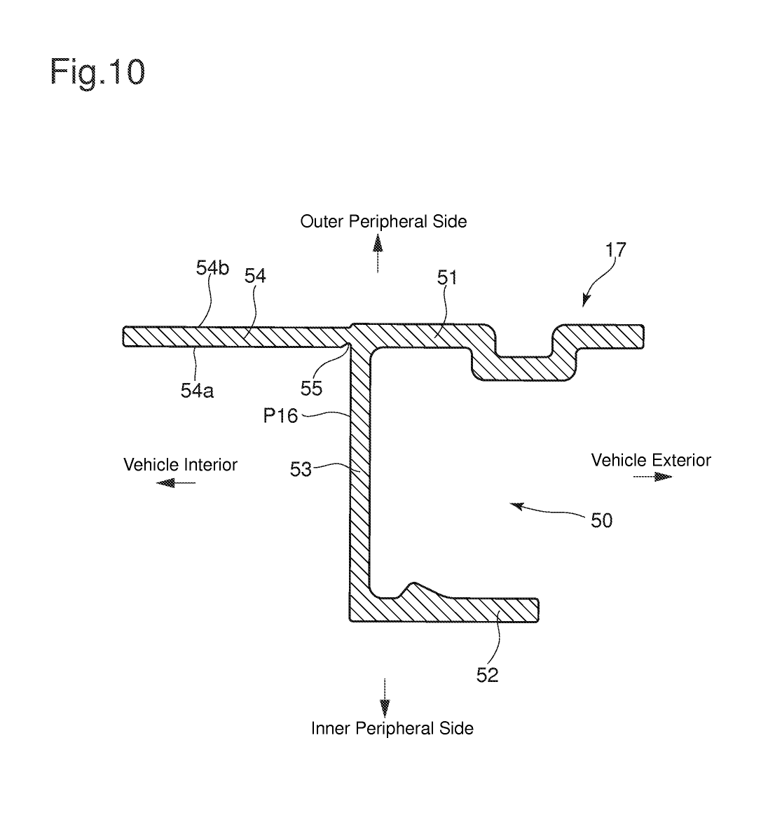

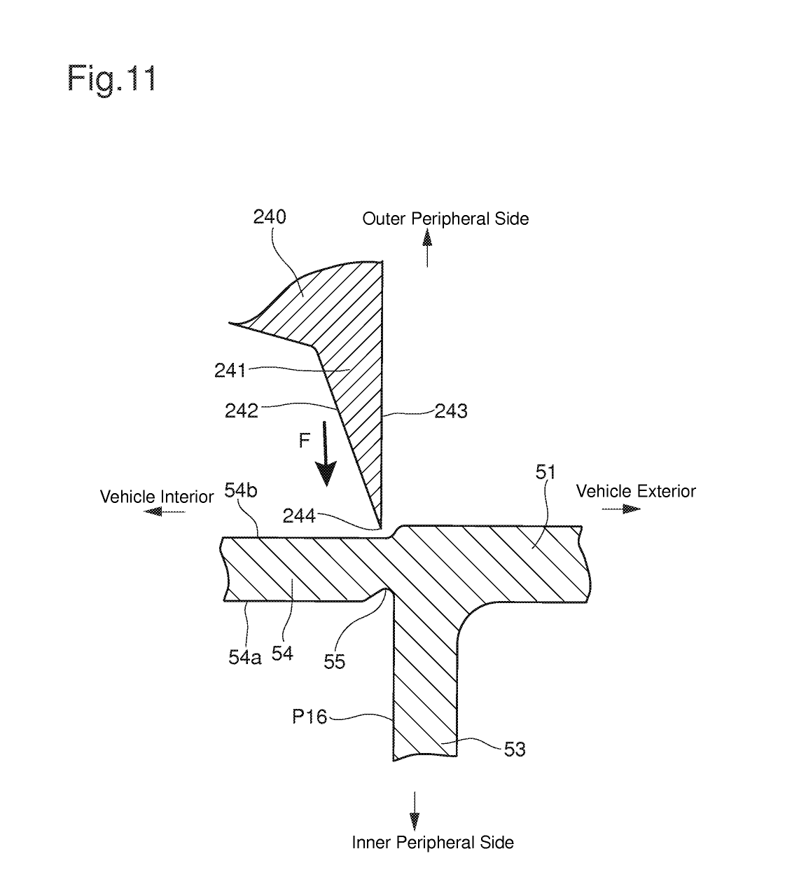

In addition, the present invention is applicable to projecting portions other than a weather strip holding portion such as the weather strip holding portion 26. The fifth embodiment of the door frame shown in FIGS. 10 and 11 is an example of such a case. FIG. 10 shows a cross section of the lower sash 17 taken along a plane substantially orthogonal to the lengthwise direction thereof. The lower sash 17 capable of holding the front edge of the window glass as described above, and the lower sash 17 is provided with a glass-guide portion 50 which is formed open toward the inner peripheral side, similar to the glass-guide portion 23 (see FIGS. 2 and 4) of the upper sash 15. The glass-guide portion 50 is a U-shaped cross section and is provided with a vehicle interior side portion 51 which is positioned on the vehicle interior side, a vehicle exterior side portion 52 which is positioned on the vehicle exterior side, and a connecting portion 53 which connects the outer peripheral side end of the vehicle interior side portion 51 and the outer peripheral side end of the vehicle exterior side portion 52. A glass run (not shown) is held in the glass-guide portion 50. The glass-guide portion 50 is further provided with a support flange 54 which projects toward the outer peripheral side with the surface of the connecting portion 53 which faces toward the outer peripheral side constituting a base surface P16. The support flange 54 is a portion of the lower sash 17 which is fastened and fixed to the door panel 12 (specifically to an inner panel which constitutes a component of the door panel 12).

The support flange 54 is provided with a first side 54a which faces toward the vehicle exterior side and a second side 54b which faces toward the vehicle interior side. The first side 54a and the second side 54b are flat surfaces which are substantially parallel to each other and extend in the lengthwise direction of the lower sash 17. As shown by an enlarged view in FIG. 11, the glass-guide portion 50 is provided, on a portion of the first side 54a (in the close vicinity of the base end of the support flange 54 adjacent to the base surface P16) with a recess 55 which is recessed toward the second side 54b.

When the support flange 54 is partly cut off from the lower sash 17, a cutting tool 240 shown in FIG. 11 is used. The cutting tool 240 is provided with a blade 241 which includes a cutting face 242, a flank 243 and a cutting edge 244, which is formed at the boundary between the cutting face 242 and the flank 243. When the support flange 54 is partly cut off from the support flange 54, the cutting edge 244 is brought into contact and cut into the second side 54b of the support flange 54, and subsequently, the cutting tool 240 continues to be moved in the working direction F shown in FIG. 11 until the blade 241 passes through the first side 54a. Similar to the holding projection 25 or 125 of each of the above illustrated embodiments, the support flange 54 is acted upon by a force which urges the support flange 54 to buckle toward the vehicle exterior side with the recess 55 acting as a buckling point, so that the blade 241 can easily cut into the support flange 54, which makes it possible to perform the cut-off process smoothly to smoothen a cut-off trace of the support flange 54, which is created as a result of partly cutting off the support flange 54 using the cutting tool 240.

Although the present invention has been described based on the above illustrated embodiments, the present invention is not limited solely thereto; various modifications to the above illustrated embodiments are possible without departing the scope of the invention. For instance, although each of the recesses 30, 31, 32 and 33 and the second recess 34 in the above described embodiments has been illustrated above as a recess having a curved cross-sectional shape (a curved inner surface), an effect similar to that obtained in each of the above described embodiments can be obtained even in the case where the recess is modified to a recess having a polygonal cross-sectional shape (a polygonal inner surface) in each of the above described embodiments.

The recess (31, 32 or 33) is formed in the first side (25b or 125b) on the vehicle interior side of each holding projection (projecting portion) 25 and 125 of the first through fourth embodiments, and the recess 55 is formed in the first side 54a in the support flange 54 of the fifth embodiment; however, it can be appropriately decided which side of the projecting portion a recess should be formed on in accordance with consideration given to the peripheral structure of the projecting portion and/or the workability of inserting a cutting tool. For instance, in a modified embodiment of the first embodiment, it is possible to set the cutting tool 40 on the vehicle interior side and then move the cutting tool 40 from the first side 25b to the second side 25c to partly cut off the holding projection 25. In this modified embodiment, it is desirable to make the holding projection 25 buckle in the direction opposite to the buckling direction in which the aforementioned force Q1 acts on the cutting tool 40, and accordingly, it is advisable to form a portion corresponding to the recess 30 on the second side 25c instead of forming the recess 30 in the first side 25b.

Obvious changes may be made in the specific embodiments of the present invention described herein, such modifications being within the spirit and scope of the invention claimed. It is indicated that all matter contained herein is illustrative and does not limit the scope of the present invention.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding Japanese Application No. 2014-218911, filed Oct. 28, 2014 are incorporated by reference herein.

What is claimed is:

1. A vehicle door frame comprising a base and a projecting portion, which projects from a surface of said base,
wherein a first side of said projecting portion and a second side of said projecting portion extend along a lengthwise direction of said vehicle door frame, and
wherein a recess is formed in said first side of said projecting portion and is recessed toward said second side of said projecting portion.

2. The vehicle door frame according to claim 1, wherein said recess is positioned at a boundary between said projecting portion and said base to be recessed into said first side of said projecting portion while being recessed into said surface of said base.

3. The vehicle door frame according to claim 1, wherein a second recess is formed in said door frame at a boundary between said second side of said projecting portion and said surface of said base to be recessed into said surface of said base.

4. The vehicle door frame according to claim 1, wherein said surface of said base comprises two surfaces which are respectively formed on either side of said projecting portion at different positions relative to a projecting direction of said projecting portion.

5. The vehicle door frame according to claim 1, further comprising:
a frame portion which includes an inner peripheral side portion which is adjacent to a window opening, an outer peripheral side portion positioned on an opposite side of said inner peripheral side portion relative to said window opening, and a connecting portion which connects said inner peripheral side portion with said outer peripheral side portion;
an extension portion which extends toward a vehicle exterior side from said outer peripheral side portion of said frame portion; and
a weather strip holding portion which holds a weather strip on said extension portion on said outer peripheral side,
wherein said projecting portion projects toward said outer peripheral side, with at least one of said outer peripheral side portion and said extension portion serving as said base, to form said weather strip holding portion.

6. The vehicle door frame according to claim 1, wherein said base and said projecting portion are elongated in said lengthwise direction of said vehicle door frame,
wherein a part of said projecting portion in said lengthwise direction of said vehicle door frame is cut off from said surface of said base.
